(19) United States
(12) Patent Application Publication
(10) Pub. No.: US 2008/0208651 A1
(43) Pub. Date: Aug. 28, 2008

(54) LEAD DISBURSEMENT SYSTEM AND METHOD

(76) Inventors: Scott JOHNSTON, Potomac Falls, VA (US); Vance Bell, Philadelphia, PA (US); John Norton, Ardmore, PA (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/844,828

(22) Filed: Aug. 24, 2007

Related U.S. Application Data
(60) Provisional application No. 60/823,436, filed on Aug. 24, 2006.

(51) Int. Cl. G06F 9/44

(52) U.S. Cl. 705/7

(57) ABSTRACT

A method includes associating a lead with a subset of participants from a plurality of participants. The associating is performed based on a criteria list. A priority is determined for each participant from the subset of participants. A capacity coefficient is determined for each participant from the subset of participants. The lead is exclusively assigned to a participant from the subset of participants based on the priority for the participant and the capacity coefficient for the participant.

### CROSS-REFERENCE TO RELATED APPLICATIONS

This application claims priority to U.S. Provisional Application Ser. No. 60/823,436, entitled “Lead Disbursement System and Method,” filed Aug. 24, 2006, which is incorporated herein by reference in its entirety.

### BACKGROUND

The invention relates generally to business methods, and more particularly to systems and methods for disbursing leads associated with investment opportunities.

Today's marketplace includes large numbers of potential buyers and sellers. To operate more efficiently, market participants often target their efforts towards a subset of participants known to be interested in their products and/or services. For example, it is inefficient for a seller of high end automobiles to distribute a mass mailing to all residents within a certain area. Rather, the seller will distribute information only to a smaller mailing list of potential buyers known to have both the requisite interest and means to purchase high end automobiles. Similarly, a buyer of real estate will focus their search efforts only on a short list of property meeting their specified criteria. Such lists are often compiled from leads, which can be generated, for example, by cold-calling, customer survey data and/or general demographic information.

To be effective, however, generated leads must be distributed to the appropriate market participants in a timely fashion. For example, the contact information for a potential buyer of insurance should be disbursed quickly to a seller of insurance that matches a set of selection criteria (i.e., one who sells the desired type of insurance, represents a particular insurance company and/or covers a particular geographic territory). Otherwise, the lead can become outdated and worthless.

Known systems exist to improve the distribution of leads. Such known systems can be configured to filter leads such that lead buyers only receive those leads that match a certain set of predefined criteria. Such systems, however, generally distribute a single lead to multiple lead buyers. In other words, there is no exclusivity for a certain type of lead if many buyers have the same or similar criteria specified.

Thus, there is a need for more sophisticated lead disbursement methods and systems.

### SUMMARY

Methods and systems for disbursing leads, such as leads within the real estate market, are described herein. In some embodiments, a method includes associating a lead with a subset of participants from a plurality of participants. The associating is performed based on a criteria list. A priority is determined for each participant from the subset of participants. A capacity coefficient is determined for each participant from the subset of participants. The lead is exclusively assigned to a participant from the subset of participants based on the priority for the participant and the capacity coefficient for the participant.

### BRIEF DESCRIPTION OF THE DRAWINGS

FIG. 1A is a flow chart illustrating a method of disbursing leads according to an embodiment of the invention.

FIG. 1B is a flow chart illustrating a method of disbursing leads that includes calculating a capacity coefficient according to an embodiment of the invention.

FIG. 1C is a flow chart illustrating a method of disbursing leads that includes evaluating a priority parameter according to an embodiment of the invention.

FIG. 2 is a flow chart illustrating a method of disbursing leads according to an embodiment of the invention.

FIG. 3 is a flow chart illustrating a method of disbursing leads according to an embodiment of the invention.

FIG. 4 is a flow chart illustrating a method of disbursing leads that reside within a lead bank according to an embodiment of the invention.

FIG. 5A is a flow chart illustrating a method of auctioning leads according to an embodiment of the invention.

FIG. 5B is a flow chart illustrating a method of exploiting leads that have been assigned an accepted according to an embodiment of the invention.

FIGS. 6 through 10 are examples of a graphical user interface (GUI) illustrating various computer-based tools according to an embodiment of the invention.

### DETAILED DESCRIPTION

Systems and methods for disbursing leads are described herein. In some embodiments, a method includes associating a lead with a subset of participants from a plurality of participants. The associating is performed based on a criteria list. A priority is determined for each participant from the subset of participants. A capacity coefficient is determined for each participant from the subset of participants. The lead is exclusively assigned to a participant from the subset of participants based on the priority for the participant and the capacity coefficient for the participant.

In some embodiments, a method includes establishing a prioritized queue of participants, receiving a lead, and determining whether the lead matches a set of selection criteria associated with the participant in the first queue position. The selection criteria can include, for example, a geographic region of interest, such as a ZIP code. When the lead matches the participant's selection criteria, it is assigned to the participant, who is then moved to the bottom of the queue. When the lead fails to match the participant's selection criteria, it is assigned to a lead bank, and the participant remains in the first queue position.

In some embodiments, a method includes establishing a prioritized queue of participants, receiving a lead, and determining whether the lead matches a set of selection criteria associated with the participant in the first queue position. When the lead fails to match the selection criteria associated with the participant in the first queue position, the lead is then compared against the selection criteria associated with the participant in the second queue position. When the lead matches the second participant's selection criteria, it is assigned to the second participant, who is then moved to the bottom of the queue. When the lead fails to match the second participant's selection criteria, however, it iteratively compared against the selection criteria associated with the remaining participants in order of their queue priority. The lead is assigned to a lead bank only after it has failed to match the selection criteria of all participants in the queue.

In some embodiments, a method includes receiving a lead into a lead bank. The lead is displayed to a subset of participants who are eligible to request the lead. The lead is assigned to the first participant from the subset of participants who requests the lead. The assigned participant is then moved to the bottom of a priority queue. When, however, a participant from the subset of participants does not request the lead within a first time period, the lead is then displayed to all participants in the lead disbursement system, each of whom can request the lead. When a participant requests the lead it is assigned to the participant, who is then moved to the bottom of a priority queue. When, however, a participant does not request the lead within a second time period, the lead is assigned to the system administrator.

In some embodiments, the total number of leads that can be assigned to a participant over a predetermined time period is limited. For example, in some embodiments, a method includes determining a capacity coefficient (described below) for each participant. The capacity coefficient can represent, for example, whether a participant has capacity to be assigned a lead and/or the maximum number of leads which can be assigned to a participant within the predetermined time period. In this manner, leads are more evenly distributed among participants in the lead disbursement system.

In some embodiments, a method includes assigning a lead to a participant according any of the above methods. When the participant so selects, the lead is transmitted to an auction system, where it is auctioned to the other participants.

The term “lead” as used herein includes any information associated with a potential business opportunity. For example, a lead can include the information associated with a piece of real estate that is currently for sale. Similarly, a lead can include the contact information for a buyer who has indicated a desire to purchase a particular type of goods and/or services. Leads can exist in a variety of forms, ranging from tangible to intangible. For example, a lead can be a piece of paper containing a person's contact information. In some embodiments, a lead can be a computer-readable file that includes information associated with a piece of real property. Conversely a lead can also be a phone conversation in which a person indicates their desire to sell and/or purchase a particular type of goods and/or services.

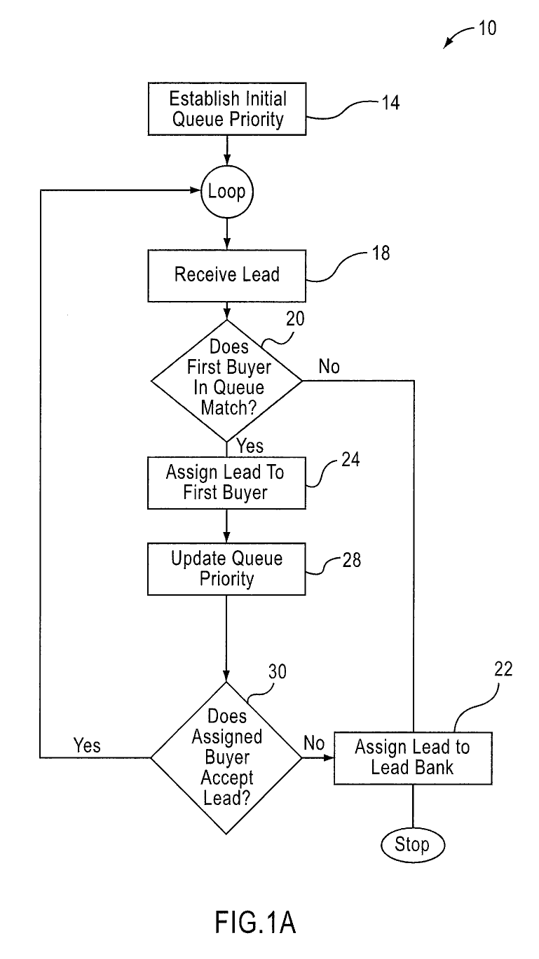

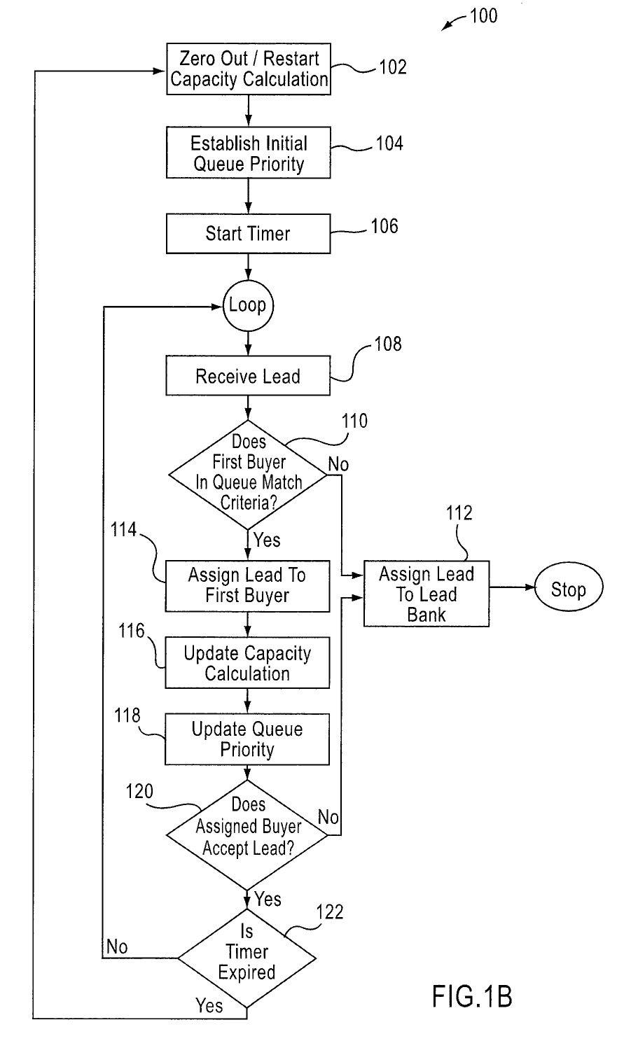

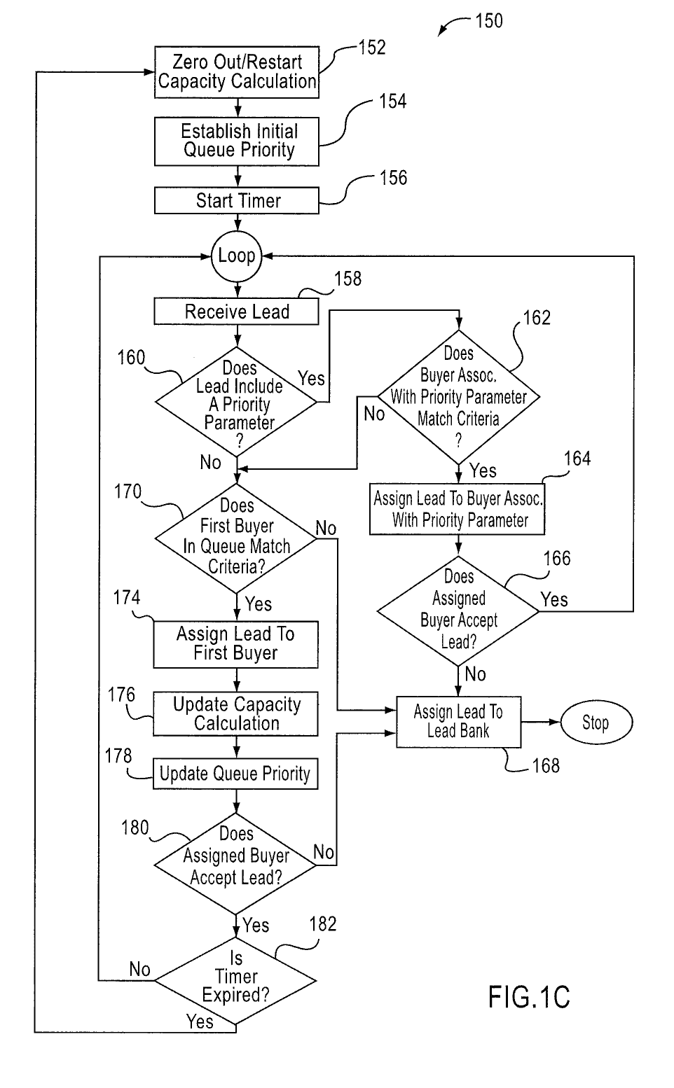

FIG. 1A is a flow chart illustrating a method 10 of disbursing leads according to an embodiment of the invention. The illustrated method includes establishing a prioritized queue of the participants in the lead disbursement system, 14. The prioritized queue can be established based on a number of factors, such as, for example, an amount of time since the participant joined the lead disbursement system, an amount of time since the participant was last assigned a lead, an amount of time since the participant last accepted a lead, an amount of the financial contribution made by the participant and/or by random assignment. In some embodiments, the priority of the participants in the queue can be based on a combination of any of the above factors.

A lead is then received into the lead disbursement system at 18. A lead can be received in a number of formats, such as, for example, an electronic file containing information associated with a business opportunity. In some embodiments, the lead can be received as an e-mail, a file attached to an e-mail and/or a data record input to a database or other computer program for manipulating information. In other embodiments, the lead can be received as a tangible item, such as a video tape, an audio tape and/or a piece of paper containing indicia and/or information associated with an business opportunity. In yet other embodiments, the lead is received in one format and is then cataloged in another format for easier manipulation within the lead disbursement system described herein. For example, in some embodiments, a lead can be received as a piece of a paper, assigned a unique identification number and then stored in a physical file. The identification number, along with other pertinent information associated with the lead, can then be input as a data record in a database for subsequent manipulation according to the methods discussed herein. In yet other embodiments, a lead can be received as a live phone call, in which the caller expresses a desire to conduct a particular type of business transaction. In yet other embodiments, a lead can be received as a combination of any of the above. For example, in some embodiments, a lead can be received as a live phone call and subsequently the same lead can be received as a data record input into a computer system.

Upon receiving the lead, the illustrated method includes evaluating the lead against the selection criteria associated with the participant having the highest queue priority, 20. Such criteria can include, for example, a category of business opportunity, a geographic region, a price range, a personal contact associated with the lead and/or a combination thereof. In some embodiments, for example, a participant can specify a particular type of business opportunity sought, such as offers to sell real estate, offers to rent real estate and/or offers for services related to real estate transactions (i.e., closing services, title insurance, and the like). In other embodiments, for example, a participant can specify a particular geographic region of interest, such as a particular region within the country (i.e., Mid-Atlantic), state, county, ZIP code, media market, subdivision plat map, voting district and/or school district. In yet other embodiments, a price range specified by a participant can include price minimums and price caps on the purchase price, a maximum transaction cost, a price range of the monthly cost, and the like. In still other embodiments, the participant can select specific personal contacts as the selection criteria. For example, a participant may want to pursue all offers to sell real estate associated with a particular real estate agent, firm and/or seller. The specific tools used to specify the selection criteria are discussed in more detail herein.

In addition to selection criteria specified by each participant, the system administrator can also specify criteria associated with each participant. In some embodiments, for example, the system administrator can adjust the participant-specified criteria based on past results or actions taken by the participant. For example, in instances where a participant has repeatedly failed to accept a lead that matches a specific criterion (i.e., a ZIP code), the system administrator can update the participant's selection criteria to exclude the specific criterion.

A number of different algorithms can be used to evaluate the received lead against the participant's selection criteria. In some embodiments, for example, the lead is considered a match if it corresponds to a single criterion associated with the participant. In other embodiments, the lead is considered a match only if it corresponds to all of the criteria associated with the participant. In yet other embodiments, each criterion is assigned a weighting and the lead is considered a match if the weighted average of criteria corresponding to the lead exceeds a predetermined threshold. As an example, a participant's criteria may include three items: 1) offers to sell real estate, 2) within a particular ZIP code and 3) within a predetermined price range. Each of the three criteria may be given an equal weight value of 5. In this example, the system may be configured to determine that a match exists when the weighted value of criteria corresponding to the received lead is greater than or equal to 10. In this case, a lead will be considered a match when any two of the three criteria correspond to the received lead.

When the received lead is not a match with the participant having the highest queue priority, the illustrated method includes assigning the lead to a lead bank, 22. The lead bank is a collection of leads that are unassigned to a participant and/or are not accepted by a participant. The disposition of leads residing within the lead bank is discussed in more detail herein.

When the received lead is determined to be a match with the participant having the highest queue priority, the illustrated method includes assigning the lead to the participant, 24. The lead can be assigned to the participant in a number of different ways, such as, for example, by e-mailing a notification to the participant, by placing a phone call to the participant, by updating a record within a database that is accessible by the participant and/or by physically delivering the lead to the participant.

Once the lead has been assigned, the illustrated method includes updating the queue priority, 28. In some embodiments, for example, the queue priority is updated by moving the assigned participant to the lowest priority (i.e., the bottom of the queue). In other embodiments, the queue priority can be updated be recalculating the factors used to establish the prioritized queue, such as those described above. In this manner, the participant may not necessarily be moved to the bottom of the queue after accepting a lead.

Once a participant has been assigned a lead, they have the option of whether or not to accept the lead, 30. This option can be exercised in a number of different ways. For example, in some embodiments, a lead assigned by sending an e-mail is considered rejected when the participant fails to open the e-mail within a predetermined time period. In this manner, the method prevents assigned leads from going stale if they are not accepted within a reasonable time period. In other embodiments, however, a lead is only considered rejected when the participant expressly notifies the system administrator of their decision to reject the lead. In yet other embodiments, a lead disbursement system can include an “automatic acceptance” feature, which allows a participant to automatically accept all leads assigned to the participant. For example, in some embodiments, a lead disbursement system can include a participant selectable “automatic acceptance and call transfer” feature. When a participant enables the call transfer feature, any leads that are received as live phone calls are automatically transferred in real-time fashion to a phone number provided by the participant to whom the lead has been assigned. For example, in some embodiments, a lead disbursement system includes a call-center for receiving live telephone leads. Upon receiving a phone call, an operator then inputs information provided by the caller into another portion of the lead disbursement system. The lead disbursement then assigns the lead to a participant according any of the methods described herein, and transfers the live call directly to the assigned participant. Each lead transferred via this option is also automatically accepted by the participant. In the illustrated embodiment, the queue priority is updated regardless of whether the participant accepts or rejects the assigned lead. In other embodiments, however, the queue priority is only updated when the participant accepts the assigned lead. Leads that are not accepted are assigned to the lead bank, as discussed above, 22.

In some embodiments, the total number of leads that can be assigned to a participant over a predetermined period of time is limited. FIG. 1B provides a flow chart illustrating one such method 100 according to an embodiment of the invention. The illustrated method 100 includes establishing (or “zeroing out”) an initial capacity coefficient for each participant in the lead disbursement system, 102. In some embodiments, for example, the capacity coefficient denotes whether a participant is eligible to receive a lead assignment during the current time period. The capacity coefficient can be, for example, a character string associated with a participant. For example, the character string “Y” can represent that a participant is eligible to receive a lead assignment. Conversely, the character string “N” can represent that a participant is not currently eligible to receive a lead assignment.

In other embodiments, the capacity coefficient represents the number of leads that can be assigned to a participant during the current time period. In such embodiments, this value can be based on, for example, a maximum number of leads that can be assigned to the participant during a predetermined time period, a number of leads previously assigned to the participant during the current time period and/or the billing status of the participant (i.e., paid in full or past due). In some embodiments, the maximum number of leads that can be assigned to a participant during a predetermined time period can be based on the participant's level of investment in the lead disbursement system, the participant's history of payment and/or past results or actions taken by the participant in response to assigned leads. For example, in some embodiments, the maximum number of leads that can be assigned to a participant during a predetermined time period is calculated using the following equation:

Max Leads=[participant investment/total investment]×[total no. of leads]

Where the participant investment is associated with a financial contribution made by the participant for a predetermined time period; the total investment is associated with the total financial contribution made by all participants for the time period; and the total no. of leads is the total number of leads received into the lead disbursement system during the time period. In instances when the above equation does not result in a whole number, the maximum number of leads value is rounded up. In this manner, the total number of leads that can be assigned will always exceed the total number of leads received into the lead disbursement system, thereby eliminating the possibility of having unassignable leads.

The illustrated method then includes establishing an initial prioritized queue of those participants eligible to be assigned leads, 104. As described above, the prioritized queue can be established based on a number of factors or combination of factors. In some embodiments, the prioritized queue is established by assigning a whole number of vouchers to each eligible participant based on their relative level of investment in the lead disbursement system. Each voucher is uniquely identified and assigned to a particular participant. The set of vouchers is then placed in a random order, which represents the prioritized queue. By including random ordering as a factor in establishing the prioritized queue, the lead disbursement system can prevent situations in which certain groups of participants, such as those who invest a relatively high amount into the system, receive too many leads over a short time period. Such a situation can arise when the prioritized queue is established without random ordering, for example, towards the end of a lead cycle (e.g., at the end of the month) when those participants making a relatively low investment are removed from the queue. As such, those participants remaining in the queue receive a disproportionate amount of leads. As described in more detail below, the assignment of vouchers is done at the beginning of each predetermined time period (e.g., at the beginning of every month).

Because the capacity coefficient limits the total number of leads that can be assigned to a participant over a predetermined time period, the illustrated method includes starting a timer, 106, to indicate the beginning of a time period. In some embodiments, the predetermined time period can be a discrete block of time, such as a year, a month and/or a day. For example, in some embodiments, the time period can correspond to a billing cycle. In such an arrangement, the capacity coefficient, the prioritized queue and/or the assignment of vouchers will be refreshed at the beginning of each billing cycle. In other embodiments, the predetermined time period does not have a fixed beginning point and end point, but is rather a continuous or “rolling” time period. For example, in some embodiments, the number of leads that can be assigned to a participant is limited over any continuous 30 day period, which can overlap a billing cycle.

The illustrated method then includes receiving a lead at 108, and determining whether the received lead matches the criteria of the participant having the highest queue priority at 110, as described above. When the received lead is not a match with the participant having the highest queue priority, the illustrated method includes assigning the lead to a lead bank, 112, as described above.

When the received lead is determined to be a match with the participant having the highest queue priority, the illustrated method includes assigning the lead to the participant, 114. The illustrated method then includes updating the capacity coefficient for each participant in the lead disbursement system, 116. In this manner each participant's capacity coefficient will reflect both the increase in the total number of leads received, as well as the assignment of the current lead.

The illustrated embodiment then includes updating the queue priority, 118. In some embodiments, for example, the queue priority is updated by moving the participant and/or the participant's assigned voucher to the lowest priority (i.e., the bottom of the queue) after they have received a lead. In other embodiments, the queue priority can be updated be recalculating the factors, such as those described above, used in determining the initial queue priority. In this manner, the participant may not necessarily be moved to the bottom of the queue. In yet other embodiments, those participants who have become eligible to receive leads (i.e., those who now have excess capacity) are added to the bottom of the queue.

The illustrated method then includes determining whether the participant has accepted the assigned lead, 120, as described above. Finally, the illustrated method includes evaluating whether the timer has expired, 122. When the timer has expired, for example, at the start of a new billing cycle, the capacity coefficient for each participant is reestablished (or “zeroed out”), as described above. Conversely, when the time period has not expired, the illustrated method loops back to step 108.

In some embodiments, a method includes assigning leads using both a prioritized queue and a priority parameter to determine the participant to whom an incoming lead should be assigned. For example, FIG. 1C provides a flow chart illustrating a method 150 of disbursing leads according to an embodiment of the invention. The illustrated method 150 includes establishing (or “zeroing out”) an initial capacity coefficient for each participant in the lead disbursement system, 152. In some embodiments, for example, the capacity coefficient can represent the number of leads that can be assigned to a participant during the current time period. For example, in some embodiments, the maximum number of leads that can be assigned to a participant during a predetermined time period is a function of a financial contribution made by the participant for a predetermined time period, as described above.

The illustrated method then includes establishing an initial prioritized queue of those participants eligible to be assigned leads, 154. As described above, the prioritized queue can be established based on a number of factors or combination of factors. Moreover, as described above, the prioritized queue can be established, in part, using a random ordering. The illustrated method then includes starting a timer, 156, as described above.

The illustrated method then includes receiving a lead, 158, and determining whether the received lead includes a priority parameter associated with a particular participant, 160. When a lead includes a priority parameter, the method includes determining whether the received lead matches the criteria of the participant associated with the priority parameter, 162. When the received lead is determined to be a match with the participant associated with the priority parameter, the illustrated method includes assigning the lead to the participant, 164. The illustrated method then includes determining whether the participant has accepted the assigned lead, 166, as described above. When the participant accepts the lead, the illustrated method loops back to step 158. Conversely, when the participant does not accept the lead, the illustrated method includes assigning the lead to a lead bank, 168, as described above. In this manner, under certain conditions, the illustrated method includes assigning a lead to a participant without regard to their position in the prioritized queue. Moreover, the illustrated method also includes assigning the lead without impacting the assigned participant's capacity for receiving future leads and/or the assigned participant's position in the prioritized queue.

In some embodiments, a priority parameter can be an alphanumeric code associated with an advertisement or promotion produced or funded by a particular participant. For example, in certain circumstances, a participant may wish to place advertisements in a medium not normally used by the system administrator, such as a local real estate circular. In this manner, the participant, by placing such an advertisement, may generate additional leads for the system that would not have otherwise been generated. When leads are generated from such an advertisement, they can be configured to include an “advertising code” associated with the participant (i.e., a priority parameter). In this manner, when such leads are received into the system, they are assigned to the participant responsible for generating the lead when the leads are determined to be a match with the participant responsible for generating the lead.

In other embodiments, a priority parameter can be an identifier supplied directly by the subject of the received lead, such as a particular seller of real estate. When a lead associated with the seller is generated, it can include the seller's preference of participants in the lead disbursement system. For example, in some circumstances the seller may have a history of dealing with a particular buyer, and therefore may prefer to deal exclusively with that buyer when possible.

When the received lead is not a match with the participant associated with the priority parameter, the illustrated method includes determining whether the received lead matches the criteria of the participant having the highest queue priority, 170, as described above. When the received lead is not a match with the participant having the highest queue priority, the illustrated method includes assigning the lead to a lead bank, 168.

When the received lead is determined to be a match with the participant having the highest queue priority, the illustrated method includes assigning the lead to the participant, 174. The illustrated method then includes updating the capacity coefficient for each participant in the lead disbursement system, 176 and updating the queue priority, 178, as described above.

The illustrated method then includes determining whether the participant has accepted the assigned lead, 180, as described above. Finally, the illustrated method includes evaluating whether the timer has expired, 182. When the timer has expired, for example, at the start of a new billing cycle, the capacity coefficient for each participant is reestablished (or “zeroed out”), as described above. Conversely, when the time period has not expired, the illustrated method loops back to step 158.

Although the method shown and described above include using a priority parameter to include a particular participant without regard to that participant's capacity or position in the queue, in some embodiments, a priority parameter can be used to exclude certain participants. For example, in some embodiments, when a lead associated with a seller is generated, it can include a one or more priority parameters associated with participants with whom the seller does not wish to deal.

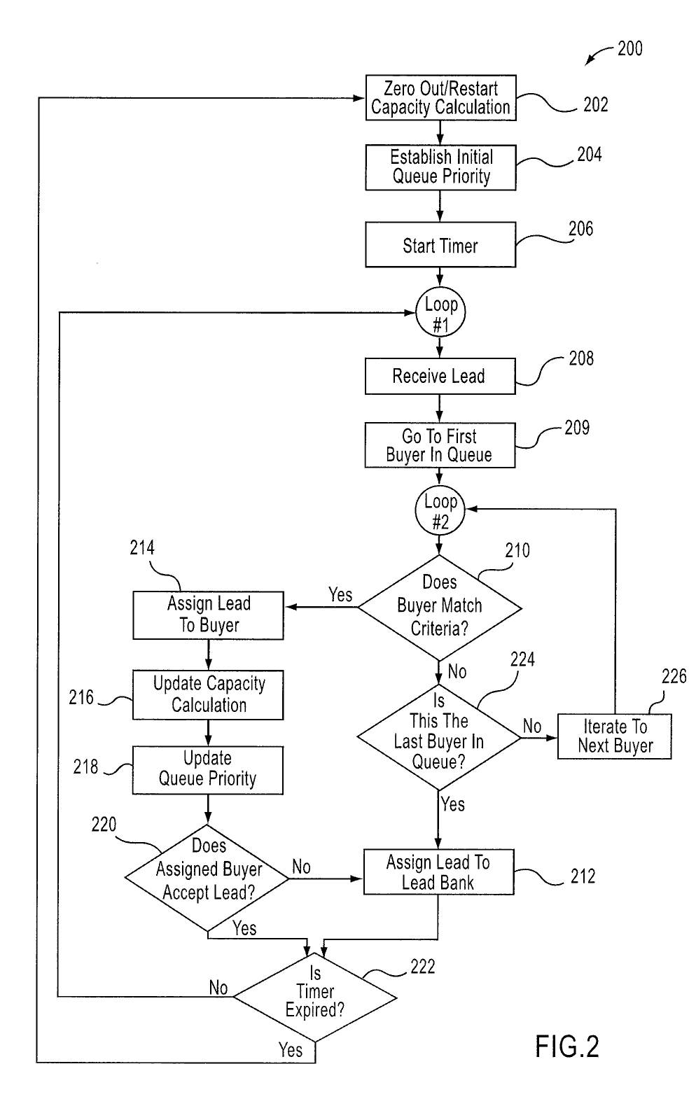

In some embodiments, a method includes evaluating the search criteria of each eligible participant before assigning a lead to the lead bank. One such “fall through” method is illustrated in the flow chart shown in FIG. 2. The illustrated method 200 includes establishing an initial capacity coefficient, 202, establishing a prioritized queue, 204, starting a timer, 206, and receiving a lead 208, as described above.

The illustrated method then includes selecting the participant having the highest queue priority, 209, and determining whether the received lead matches the selection criteria of the selected participant, 210. When the received lead is determined to be a match with the selected participant, the illustrated method includes assigning the lead to the participant, 214, updating the capacity coefficient for each participant in the lead disbursement system, 216 and updating the prioritized queue, 218, as described above. The illustrated method then includes determining whether the participant has accepted the assigned lead, 220, as described above. When the assigned participant does not accept the lead, it is assigned to the lead bank 212.

The illustrated method 200 differs from method 100 in that when the received lead does not match the participant having the highest queue priority, it is not immediately assigned to the lead bank. Rather, the illustrated method includes iteratively evaluating the lead against the selection criteria associated with the remaining participants in the queue, 226. Only when the lead is not a match with any participants in the queue, as determined at 224, is the lead assigned to the lead bank at 212.

As described above, the illustrated method includes determining whether the predetermined time period has expired, 222, and iterating accordingly.

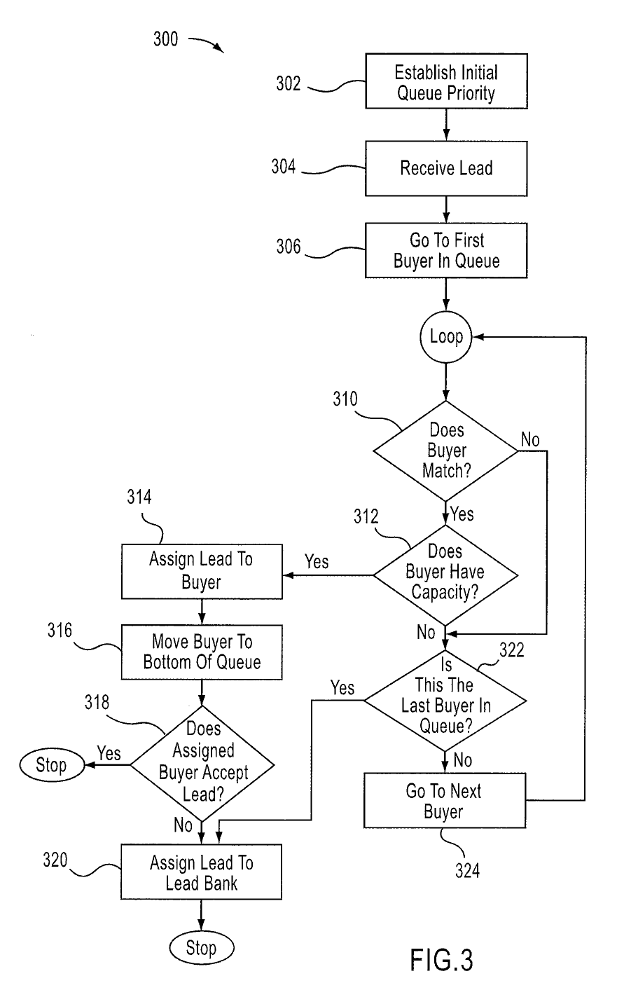

In the embodiments illustrated and described above, those participants who are ineligible to be assigned leads (i.e., those who do not have excess capacity) are excluded from the prioritized queue. As such, when a participant regains eligibility during the pendency of a time period, that participant is added to the bottom of the queue priority. FIG. 3 is a flow chart illustrating a method 300 of disbursing leads according to an embodiment of the invention in which an ineligible participant retains their queue priority. The illustrated method 300 is similar to the method 200 and, as such, the details of analogous steps are not discussed in detail. The illustrated method includes establishing an initial queue priority, 302. Unlike method 200, the initial queue priority established at 302 includes all participants in the lead disbursement system.

The illustrated method then includes receiving a lead, 304, selecting the first participant in the queue, 306 and determining whether the received lead matches the selection criteria of the selected participant, 310. When the received lead is determined to be a match with the selected participant, the illustrated method includes determining whether the participant has excess capacity to be assigned leads, 312. In this manner, the capacity coefficients for each participant are updated individually (i.e., when a lead match is established), rather than in a batch process as shown in method 200. When it is determined that the participant has excess capacity, the method includes assigning the lead to the participant, 314, and updating the queue priority, 316, as described above. The illustrated method then includes determining whether the participant has accepted the assigned lead, 318, as described above. When the assigned participant does not accept the lead, it is assigned to the lead bank 320.

When the received lead is not a match with the selected participant, the illustrated method includes iteratively evaluating the lead against the selection criterion associated with the remaining participants in the queue, 324. Only when the lead does not match any participants in the queue, as determined at 322, is the lead assigned to the lead bank at 320.

Similarly, when the received lead is determined to be a match with the selected participant, but the selected participant does not have excess capacity, the illustrated method includes iteratively evaluating the lead against the selection criterion associated with the remaining participants in the queue, 324.

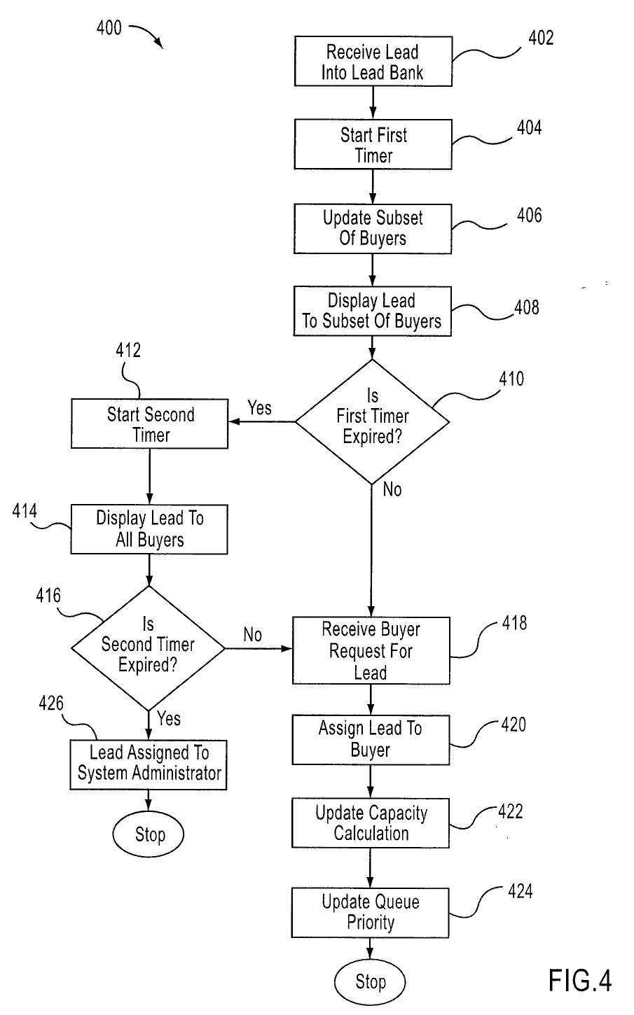

FIG. 4 is a flow chart illustrating a method 400 of disbursing leads included in a lead bank according to an embodiment of the invention. The illustrated method includes receiving a lead into a lead bank, 402. The lead bank can be, for example, a collection of leads that are unassigned and/or have not been accepted by a participant. In some embodiments, the lead bank is a separate database containing leads that are unassigned and/or have not been accepted by a participant. In other embodiments, the lead bank is not a physically or conceptually different location, but is rather a designation applied to leads within the lead disbursement system indicating that those leads that are assigned to the lead bank. Bearing this in mind, a lead can be received into the lead bank in a number of formats, such as, for example, an e-mail, a file attached to an e-mail and/or a data record input to a database. In other embodiments, the lead can be received into the lead bank as a tangible item, such as a video tape, an audio tape and/or a piece of paper. In yet other embodiments, the lead is received into the lead bank by merely designating it as residing within the lead bank.

Upon receiving the lead, the illustrated method includes initializing a first time period, 404. The first time period can be, for example, a number of weeks, days or hours. In some embodiments, for example, the first time period is forty-eight hours. In other embodiments, the first time period can be a variable associated with the occurrence of an event. For example, the first time period can be set to expire when the number of leads in the lead bank exceeds a predetermined value.

The illustrated method then includes establishing a subset of participants within the lead disbursement system, 406. In some embodiments, the subset includes all eligible participants as determined based on the capacity coefficients, as described above. In other embodiments, the subset of participants can include only eligible participants who are identified as “premier subscribers.” For example, in some embodiments, participants can be included in the subset of participants by paying an additional fee.

The illustrated method then includes displaying the lead to the established subset of participants, 408. The lead can be displayed to the subset of participants in a number of different ways, such as, for example, by e-mailing each participant, by placing a phone call to each participant, by updating a record within a database that is accessible by each participant and/or by physically delivering the lead to each participant. In this manner, each participant in the subset of participants has an opportunity to request the lead, whereas the lead is not displayed to those participants not in the subset of participants.

Once the lead has been displayed, the method includes continually determining whether the first time period has expired at 410. Upon the expiration of the first time period, the illustrated method includes initializing a second time period, 412. The second time period can be either a finite time period or a variable based on the happening of an event, as described above. In some embodiments, the second time period is forty-eight hours.

During the pendency of the second time period, the illustrated method includes displaying the lead to all participants in the lead bank system, 414. In this manner, the lead is restricted only to those participants included in the subset of participants during the first time period, but is available to all participants during the second time period. In either instance, the method includes receiving a request for the lead, 418. When a valid request is received, the method includes assigning the lead to the participant, 420, updating the capacity coefficient for each participant in the lead disbursement system, 422 and updating the prioritized queue, 424, as described above. In some embodiments, however, a method does not include updating the capacity coefficient for each participant and/or updating the prioritized queue.

In some instances, the system administrator may receive multiple requests at step 418, thereby necessitating the competing requests be prioritized. In some embodiments, the priority is based on the first participant to respond (i.e., first-come, first-served). In other embodiments, the requests can be prioritized in a manner similar to that described above for establishing a prioritized queue.

Upon the expiration of the second time period, as determined at 416, the lead is assigned to the system administrator at 426. Once a lead becomes the property of the system administrator, the system administrator can then transfer the lead to a secondary disbursement system (i.e., one that includes a different set of participants), directly sell the lead to another lead purchaser and/or act upon the lead. In some embodiments, for example, the system administrator can transfer the lead to a secondary distribution system that includes participants who provide services for real estate transactions, such as real estate agencies, mortgage lenders, and the like. In other embodiments, the system administrator can sell the lead to a real estate agency that may then list the lead using standard practices, such as the Multiple Listing Service (“MLS”). In yet other embodiments, the system administrator and/or an entity affiliated with the system administrator can list the lead using standard practices. In this manner although the participants in the primary lead disbursement system (i.e., the buyers and seller of real property) did not act upon the lead, some value related to the lead can be generated.

Although the method 400 is shown and described as including two classes of participants and two distinct time periods, in some embodiments a method can include three or more classes of participants and three or more time periods.

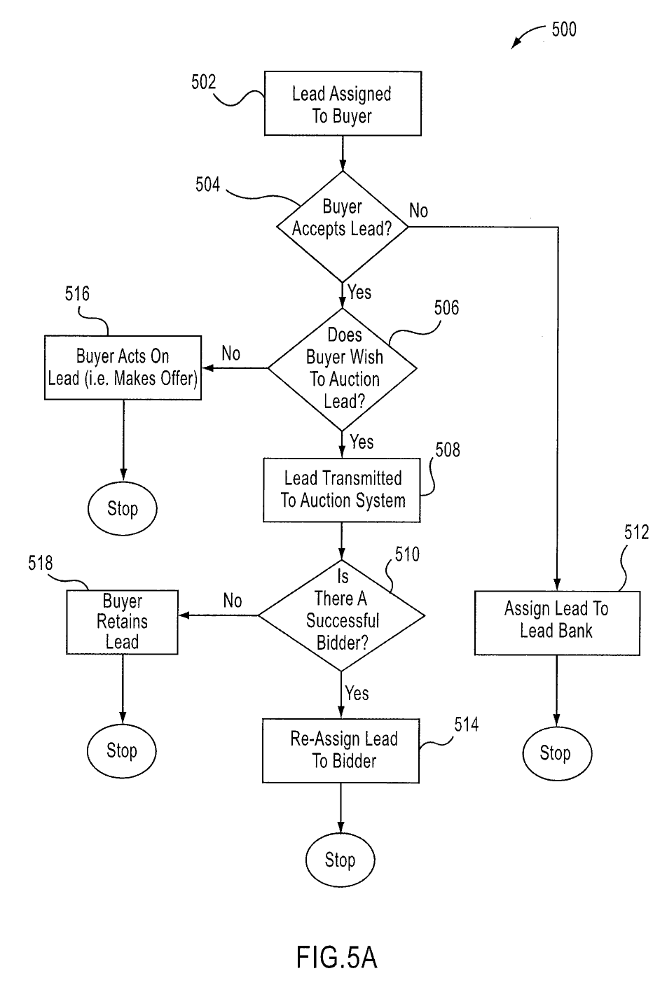

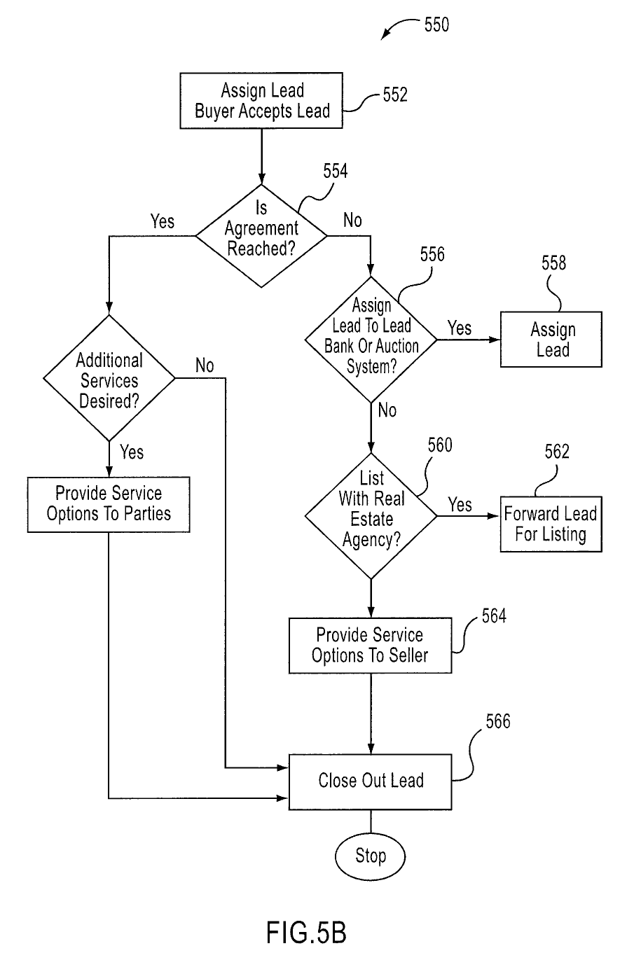

FIG. 5A is a flow chart illustrating a method 500 of auctioning leads according to an embodiment of the invention. The illustrated method 500 includes assigning a lead to a participant, 502. Such assignment can be made using any of the methods described above. The method then includes determining whether the participant accepts the lead, 504. When the participant declines to accept the assigned lead, the lead is assigned to a lead bank, 512, according to the methods described above.

When the participant accepts the lead, the method includes determining whether the participant desires to auction the lead at 506. When the participant does not wish to auction the lead, they are free to act on the lead, 516, for example, by contacting the seller or buyer associated with the lead. When, however, the participant wishes to auction the lead, the lead is transmitted to an auction system 508. Similar to the lead bank, in some embodiments, the auction system can be a separate system in which leads are auctioned among participants. In other embodiments, the auction system is not a physically or conceptually different location, but is rather grouping of leads within the lead disbursement system that are designated as available to be assigned to the highest bidder.

When a successful bidder is determined at step 510, the lead is then reassigned from the participant to the successful bidder, 514. At this point, the proceeds from the auction can be divided between the auctioning participant and the system administrator according to a predetermined arrangement. For example, in some embodiments, the system administrator will receive a flat fee for facilitating the auctioning process. In other embodiments, the system administrator will receive a percentage of the total proceeds. If no successful bidder exists, the lead remains the property of the participant to whom it was originally assigned, 518. As described above with reference to the method 400, in some embodiments, a method of auctioning leads can include multiple time periods and multiple hierarchies of bidders.

In addition to providing a method for auctioning leads, in some embodiments, a lead disbursement system includes a method for brokering leads that have been assigned to and accepted by a participant. Such a method can include, for example, transferring the ownership of a lead to the system administrator, for a flat fee. Upon such a transfer, the system administrator is then free to resell or dispose of the lead in any suitable manner, without requiring further approval of the original owner. In other embodiments, such a method can include transferring possession of the lead to the system administrator on a consignment basis. Upon such a transfer, the system administrator can then dispose of the lead according to an agreed upon set of criteria. In some embodiments, the method includes tracking the disposition of the lead and determining the appropriate division of the proceeds from the disposition.

In addition to providing a method for auctioning leads, in some embodiments, a lead disbursement system includes a method for exploiting leads after they have been assigned to and accepted by a participant. FIG. 5B is a flow chart illustrating one such method 550 of exploiting leads that have been accepted according to an embodiment of the invention. The illustrated method 550 includes assigning a lead to a participant who accepts the lead, 552. The lead assignment and acceptance can be completed using any of the methods described above. The method then includes determining whether the participant and the seller (i.e., the subject of the lead) have reached an agreement, 554. When the participant and the seller fail to reach an agreement (i.e., an unconsummated lead), the method includes determining whether the unconsummated lead should be assigned to the lead bank or the auction system, 556. In some embodiments, for example, an unconsummated lead is assigned to the lead bank or an auctioning system if it is known that no agreement has been reached within a relatively short period of time after the lead was assigned to the participant. In such cases, the lead may still be considered “hot” enough to allow other participants within the lead disbursement system to pursue the lead via the lead bank or an auctioning system. In other embodiments, the determination of whether an unconsummated lead should be assigned to the lead bank or an auctioning system is based on a number of factors other than the length of time since the lead was issued or accepted, such as, for example, a category of business opportunity, a geographic region associated with the lead, a price range and/or a combination thereof. When it is determined that the unconsummated lead should be assigned to the lead bank or the auction system, the illustrated method includes making such an assignment, 558, by any of the methods described above.

When it is determined that the unconsummated lead should not be assigned to the lead bank or the auction system, the illustrated method includes determining whether the unconsummated should be forwarded to a real estate agency for listing via standard practices, such as the Multiple Listing Service (“MLS”), 560, and forwarding the lead as appropriate, 562. In some embodiments, for example, the unconsummated lead will be forwarded for listing at the direction of the seller (i.e., the subject of the lead). In this manner, the seller can pursue other options for selling the property in light of the fact that the lead did not result in an agreement. For example, in some embodiments, the unconsummated lead can be forwarded to a local real estate agency associated with the geographic region of the lead. In other embodiments, the unconsummated lead can be forwarded to a national real estate agency. Such local or national real estate agencies can be either independent from, or affiliated with, the system administrator. In yet other embodiments, when the unconsummated lead is associated with a property in an area in which the system administrator is licensed, the lead can be assigned to the system administrator for listing.

In other embodiments, for example, the unconsummated lead will be forwarded to other service providers at the direction of the seller (i.e., the subject of the lead). For example, in some embodiments, the unconsummated lead can be forwarded to a mortgage lender and/or broker associated with the geographic region of the lead. In this manner, the seller can take the step of arranging financing for potential buyers. In other embodiments, the unconsummated lead can be forwarded to a contractor associated with the geographic region of the lead. In this manner, the seller can get assistance in making repairs, additions and/or modifications to the property to increase the likelihood of a sale.

In some instances, however, a seller will elect not to have the unconsummated lead forwarded to a real estate agency for listing. In such instances, the seller may have decided to sell the property independently. To accommodate such instances, the illustrated method includes providing a series of service options designed to assist such “do-it-yourself” sellers, 564. In some embodiments, for example, the seller can be presented with the option of having the system administrator provide a discounted listing. In such an arrangement, the system administrator can list the lead for a discounted fee without providing additional services traditionally offered by real estate agencies, such as showing the property, pre-screening potential buyers, etc. In other embodiments, the seller can be presented with a variety of tools, such as signs, checklists, internet tools and the like, designed to assist them in selling the property without engaging a real estate agency.

Upon presenting the seller with the options at step 562, the method includes closing out the lead, 566. In this manner, the lead disbursement system can be updated to reflect that the lead has been fully exploited. In some embodiments, closing out the lead can involve updating a variety of databases, thereby allowing the system administrator to track the effectiveness of the system.

When the participant and the seller reach an agreement (i.e., a consummated lead), the method includes determining whether the seller (i.e., the subject of the lead) and/or the buyer (i.e., the participant in the lead disbursement system) desire additional services associated with the lead, 570. For example, in some instances, either party may desire assistance in negotiating, arranging for various inspections, obtaining a mortgage and the like. The determination of whether such additional services are desired can be based on input from the participants and sellers. For example, in some embodiments, the participant can indicate such preferences as a part of their selection criteria, as previously described. Similarly, in other embodiments the seller can input such preferences when transmitting a lead into the lead disbursement system. When such services are desired, the illustrated method includes providing offers for various services, 572, and closing out the lead, 566. In instances when such services are not desired, the illustrated method includes closing out the lead, 566, as described above.

The operations described above can be performed either automatically or manually. An operation is done automatically when it is done without any human intervention. For example, in some embodiments, a prioritized queue is determined automatically using a rules-based algorithm that is designed to run on a computer. In other embodiments, however, the transmittal of a lead to an auction system may require input (i.e., approval) from a user, such as the system administrator.

In some embodiments, a system (not illustrated) for disbursing leads includes a processor and a memory device. The processor can be a commercially-available processing device configured to perform one or more specific tasks. For example, the processor can be a commercially-available microprocessor. Alternatively, the processor can be an application-specific integrated circuit (ASIC) or a combination of ASICs, which are designed to perform one or more specific functions. In yet other embodiments, the processor can be an analog or digital circuit, or a combination of multiple circuits.

The memory device can include one or more types of memory. For example, the memory device can include a read only memory (ROM) component and a random access memory (RAM) component. The memory device can also include other types of memory suitable for storing data in a form retrievable by the processor, for example, electronically programmable read only memory (EPROM), erasable electronically programmable read only memory (EEPROM), or flash memory.

In yet other embodiments, a system for disbursing leads according to the methods described herein can include software in the form of processor-readable code instructing a processor to perform the functions described herein. In other embodiments, such a system can include firmware that performs the functions described herein.

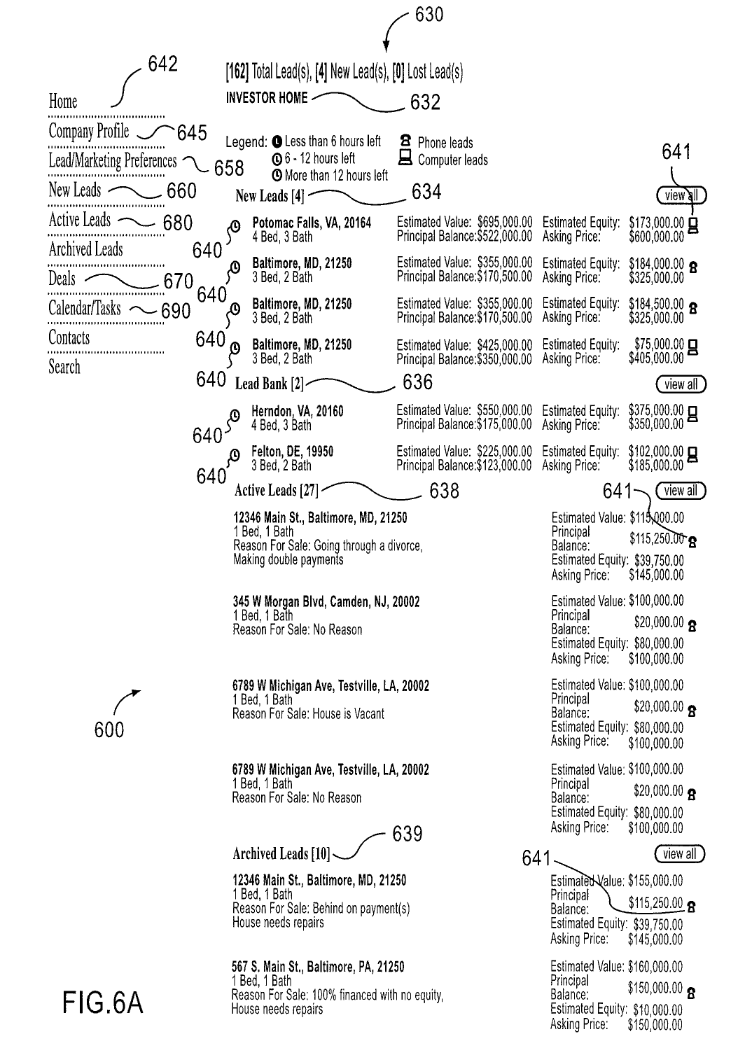

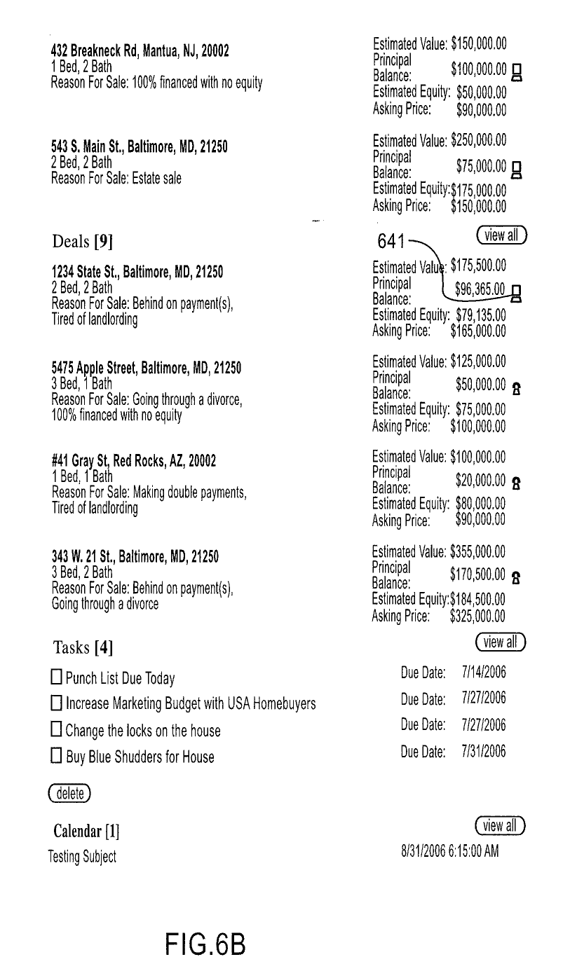

FIGS. 6-10 are examples of a graphical user interface (GUI) illustrating a lead disbursement system configured to implement the methods shown and described above. As discussed herein, the lead disbursement system 600 includes various computer-based tools. FIGS. 6A and 6B illustrate a menu driven management tool 630 configured to allow a participant to manage all aspects of their participation in the lead disbursement system 600. The participant can access the management tool 630 in a number of different ways, for example, by logging onto to the lead disbursement system 600 via the Internet.

The management tool 630 includes a participant home page 632, which is a screen display showing all lead activity pertaining to the participant. The participant home page 632 includes a section 634 displaying new leads, which are leads currently assigned to the participant that have not been accepted by the participant. Similarly, the participant home page 632 includes a section 636 displaying leads included in the lead bank that are available to the participant. Both new leads and leads in the lead bank are displayed with an indicia 640 and accompanying legend indicating the status of the time period(s) associated with the lead, as discussed above. Although the indicia 640 is shown as being a visual indicia, such as an icon, a color-coding, a numerical representation or the like, in some embodiments, the indicia can include an audible component and/or a haptic component.

The participant home page 632 also includes a section 638 of active leads, which are leads that have been accepted by and are being actively pursued by the participant. Similarly, the participant home page 632 includes a section 639 listing those leads that have been accepted by the participant, but that have been archived for follow up at a later time. Each of the above mentioned sections displays leads with an indicia 641, such as an icon, a color-coding, and the like, indicating whether the lead is a phone lead or a computer lead. In some embodiments, the indicia 641 can indicate other characteristics of the lead, such as, for example, whether the lead is “live,” the origin of the lead and/or whether the subject of the lead is related to any other leads in the system (i.e., multiple properties having common ownership).

Such a characterization of a new lead can be important, for example, to determine whether any surcharge should be levied against the participant to whom the lead was assigned. For example, in some embodiments a lead disbursement system can include a call-center in which operators receive incoming leads as live phone calls. In such an arrangement, the quality of the lead (e.g., the accuracy and/or amount of information received) may be better than that for leads received via other methods, such as via the internet. By characterizing an incoming lead, the lead disbursement system can distribute the costs associated with providing a call-center to those participants to whom such leads are assigned.

The illustrated management tool 630 includes a menu 642 that allows a participant to manage their activity within the system in more detail. For example, as illustrated, the participant can use the menu 642 to access the following screens: (1) a company profile screen 645 configured to allow the participant to input information about their company; (2) a preferences screen 650 configured to allow the participant to input their selection criteria (i.e., marketing preferences); (3) a new leads screen 660 configured to provide detailed information associated with new leads assigned to the participant; (4) an active leads screen 680 configured to provide information associated with those leads accepted by the participant; (5) a deals screen 670 configured to provide information related to ongoing deals; and (6) a calendar screen 690 configured to allow the participant to manage their activity. Other screens that can be included include a lead bank screen, an archived leads screen, a contacts screen, a payment/investment screen and/or an auction system screen.

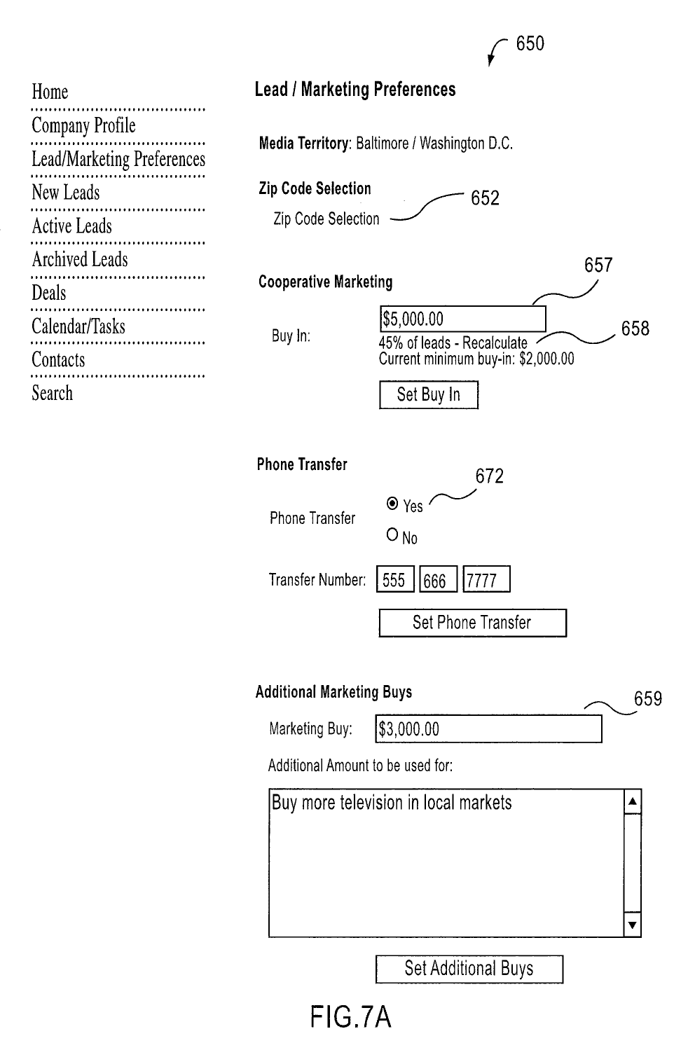

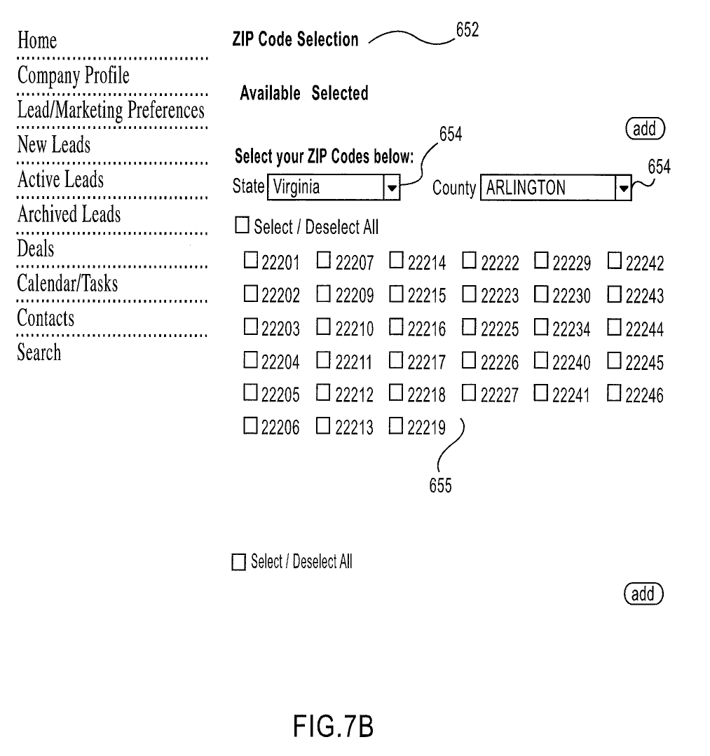

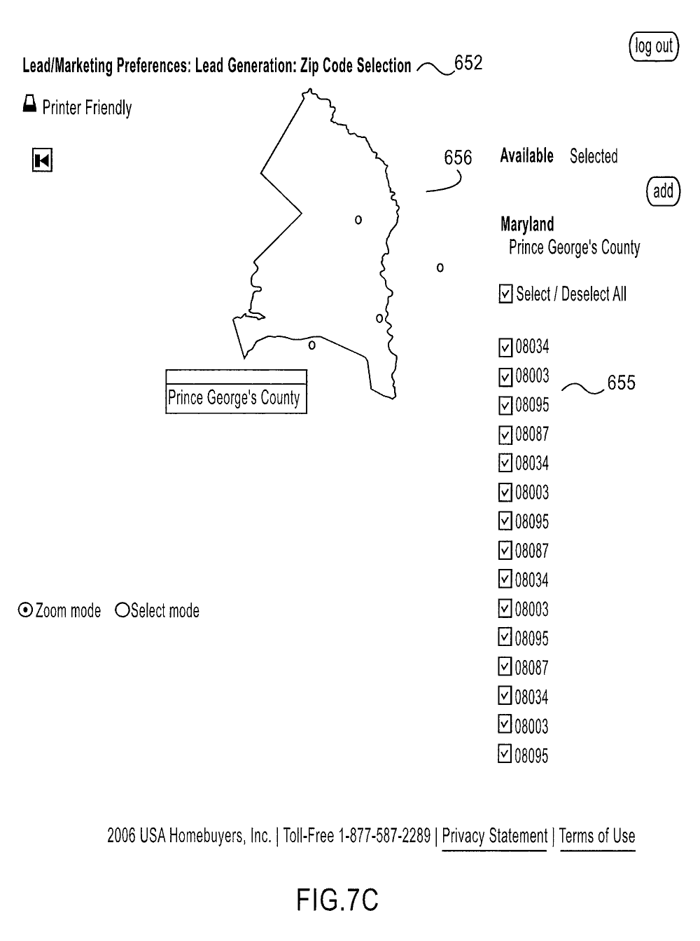

FIGS. 7A-7C illustrate an preferences screen 650 configured to allow the participant to input their selection criteria. The input screen includes a section 652 configured to allow a participant to input their selection criteria. As shown in FIG. 7B, in some embodiments, the participant can select a desired geographical region via a drop-down list 654 and/or a selection/deselection list 655. As shown in FIG. 7C, in other embodiments, the participant can graphically input their selection criteria using an interactive map 656. In other embodiments, the input screen includes one or more drop-down lists to facilitate the input of the selection criteria. Although the illustrated input screen includes only a single selection criterion, as described above, in some embodiments, the selection criteria can include many different items.

The preferences screen 650 is also configured to allow the participant to input the amount of their financial contribution towards the shared marketing effort. This can be accomplished using a selection box 657. As discussed above, in some embodiments, the amount of financial contribution can be used to determine the participant's capacity for receiving lead assignments. In the illustrated embodiment, the lead disbursement system 600 is configured to produce a real-time calculation 658 of the participant's relative capacity for lead assignments based on their financial contribution. The preferences screen also includes a section 659 that allows the participant to input an additional marketing contribution. As discussed above, such additional marketing contributions can be earmarked for local adverting and/or promotions. In this manner, the participant can receive a priority parameter associated with such additional advertising, thereby enhancing their chances of being assigned leads.

The preferences screen 650 is also configured to allow the participant to select the automatic phone transfer feature via an input area 672. In this manner, any live phone leads assigned to the participant will automatically be accepted and transferred by the system to the selected telephone number. Although shown as including only a single transfer telephone number, in other embodiments, the input area 672 can include multiple telephone numbers listed in an order of priority. The preferences screen 650 can also include a section (not shown) configured to allow the participant to enable an automatic acceptance feature, as discussed above.

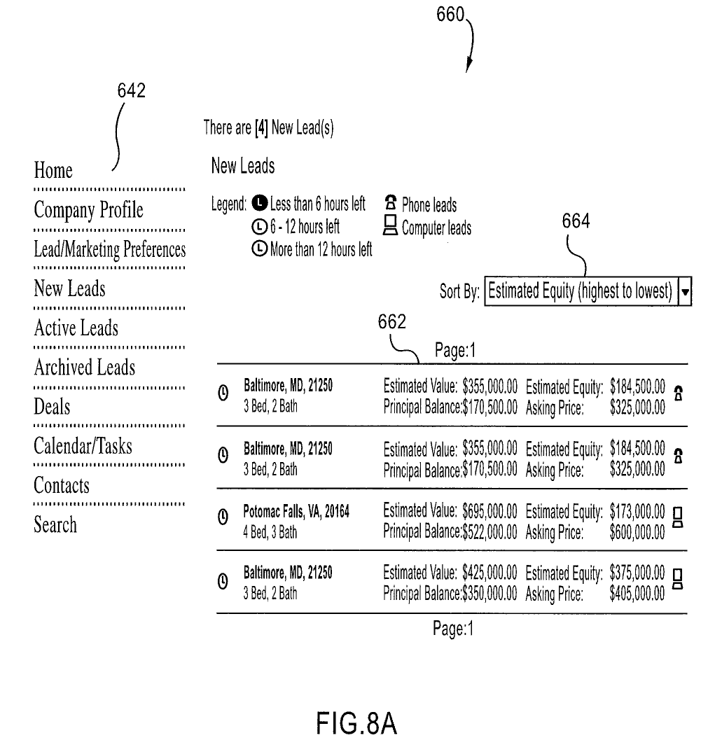

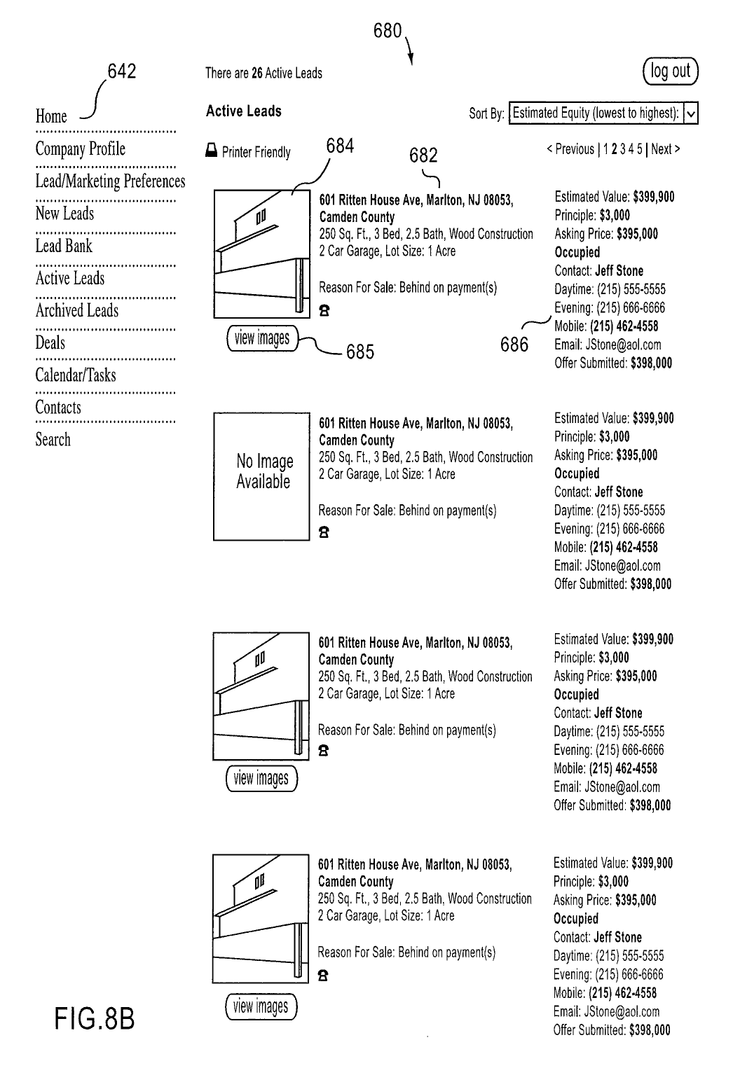

FIG. 8A illustrates a new leads screen 660 configured to provide detailed information associated with new leads assigned to the participant. The new leads screen 660 includes a section 662 displaying strategic information to help the participant determine whether to accept or decline the assigned lead. Such strategic information can include, for example, the estimated value of the property, the amount of equity in the property, the reason that the property is being offered for sale (i.e., moving, divorce, lost job) and/or the condition of the property. The new leads screen also includes a sort feature 664 that allows the participant to sort the new leads by various categories presented in a drop-down list. In some embodiments, the new leads screen 660 can include the amenities of the real estate associated with a new lead, such as the number of bedrooms, the overall size and/or the lot size. In other embodiments, the new leads screen 660 is a menu driven tool that allows the participant to select additional information about a given lead. For example, in some embodiments the new leads screen 660 can include a “view images” option.

In other embodiments, the new leads screen 660 includes the main menu 642, thereby allowing the participant to efficiently navigate among the available features included in the lead disbursement system 600.

FIG. 8B illustrates an active leads screen 680 configured to provide detailed information associated with active leads assigned to and accepted by the participant according to an embodiment of the invention. The active leads screen 680 includes a section 682 displaying the amenities of the real estate associated with a lead, such as the number of bedrooms, the overall size and/or the lot size. The active leads screen 680 also includes a photograph 684 of the property associated with each active lead, as well as a selection button 685 configured to allow the participant to access additional photographs, post new photographs and/or delete photographs associated with the lead. The active leads screen 680 includes a section 686 displaying additional strategic information associated with the lead, such as the contact information of the subject of the lead (i.e., the seller), the current offer submitted, and the like.

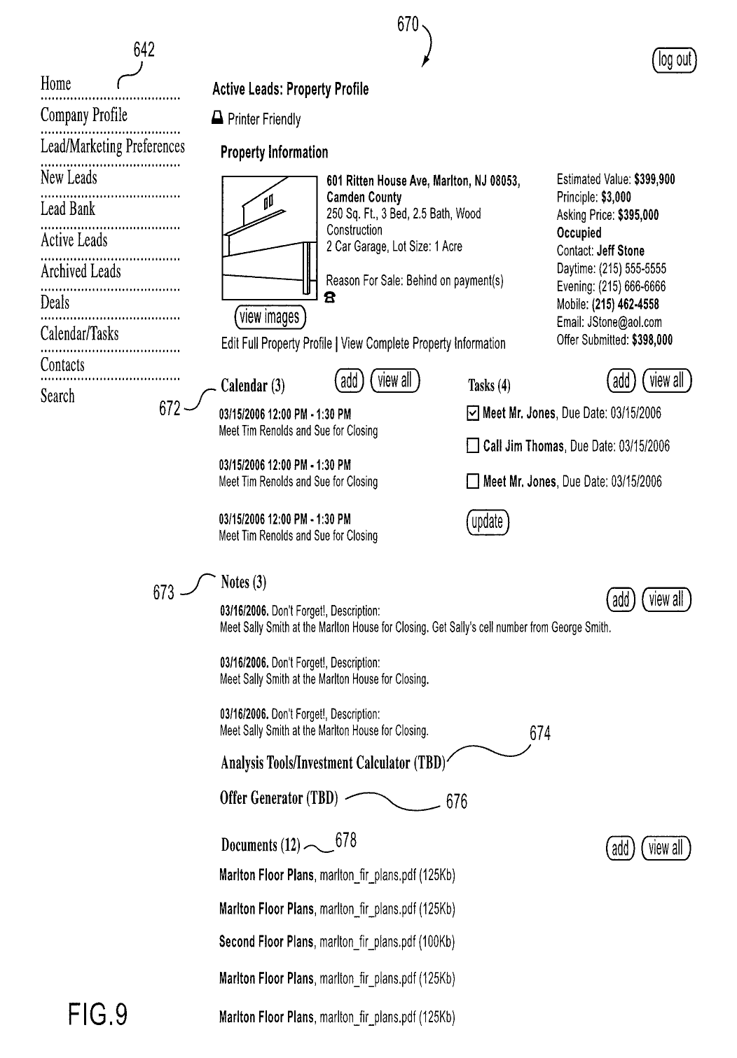

FIG. 9 illustrates an interactive deals screen 670 configured to allow the participant to input information, complete transactions, and the like. For example, in some embodiments the deals screen 670 includes a calendar portion 672 configured to allow the participant to organize tasks and events associated with the potential deal. In other embodiments, the deals screen 670 includes a notes portion 673 configured to allow the participant to input personalized notes and information. In yet other embodiments, the deals screen 670 includes a calculator 674 configured to complete various calculations, such as estimated monthly payments, estimated taxes, estimated closing costs and the like. In still other embodiments, the new leads screen 670 includes a offer generator 676, which can be an interactive tool configured to allow the participant to make an offer based on a lead. In still other embodiments, the deals screen 670 can include a documents portion 678 configured to allow the participant to access, add and/or delete documents associated with the subject of the lead. Such documents can include, for example, floor plans, tax records, appraisals, mortgage documents and the like.

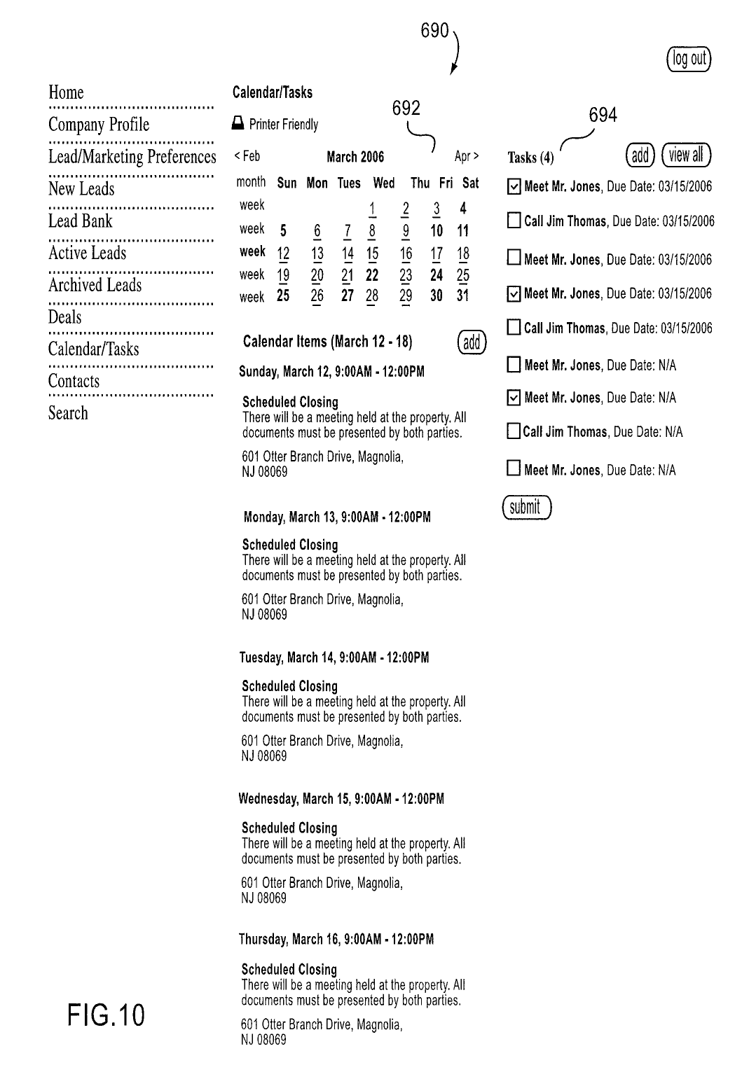

FIG. 10 illustrates a calendar screen 690 configured to allow the participant to interactively manage their activity. In some embodiments, the calendar screen 690 includes an interactive calendar portion 692 in which the participant can enter and schedule appointments. In other embodiments, the calendar screen 690 includes an a task portion 694 configured to allow the participant to input various tasks.

In addition to performing the functions as described above, in some embodiments, the lead disbursement system can be configured to communicate with other computer based systems. For example, in some embodiments, the lead disbursement system can be configured to communicate information pertaining to a particular piece of real estate to a real estate listing system. In some embodiments, the real estate listing system can be included within the overall hierarchy of the lead disbursement system. In other embodiments, the real estate listing system can be separate from the lead disbursement system. In this manner, the information included in the lead disbursement system, such as the description and location of the property, can be used to pre-populate the corresponding data fields in the real estate listing system. This function can be used, for example, by a participant in the lead disbursement system who routinely purchases property based on assigned leads and then resells the property via different channels (i.e., a real estate listing system).

While various embodiments of the invention have been described above, it should be understood that they have been presented by way of example only, and not limitation. For example, although the above methods are shown and described above as a series of operations occurring in a particular order, in some embodiments, certain operations can be completed in a parallel fashion. In other embodiments, the operations can be completed in an order that is different from that shown and described above.

Although the computer-based tools have been shown and described above as being accessible through certain screens, in other embodiments, the functionality of the computer-based tools can be included and/or accessed through a variety of screens. For example, in some embodiments, images of a property associated with a lead can be viewed via both a new leads screen, a deals screen and/or the participant home page.

What is claimed is:

1. A method, comprising:
associating a lead with a subset of participants from a plurality of participants, the associating performed based on a criteria list;
determining a priority for each participant from the subset of participants;
determining a capacity coefficient for each participant from the subset of participants; and
assigning exclusively the lead to a participant from the subset of participants based on the priority for the participant and the capacity coefficient for the participant.

2. The method of claim 1, wherein the determine the priority includes:
assigning a predetermined number of vouchers to each participant from the plurality of participants based on a contribution by each participant from the plurality of participants; and
randomly selecting a voucher from the predetermined number of vouchers.

3. The method of claim 1, wherein the determining the priority includes determining the priority within a predefined time period.

4. The method of claim 1, wherein the criteria list includes a geographical criterion.

5. The method of claim 1, wherein the lead is associated with a real property.

6. A method, comprising:
associating a lead with a subset of participants from a plurality of participants, the associating performed based on a criteria list;
determining a priority for each participant from the subset of participants;
assigning exclusively the lead to a first participant from the subset of participants based on a priority for the first participant; and
auctioning the lead to a second participant from the subset of participants when the first participant from the subset of participants does not accept the lead after the assigning.

7. A method, comprising:
associating a lead with a subset of participants from a first plurality of participants, the associating performed based on a first criteria list;
determining a priority for each participant from the subset of participants from the first plurality of participants;
assigning exclusively the lead to a first participant from the subset of participants from the first plurality of participants based on a priority for the first participant; and
reassigning the lead to a subset of participants from a second plurality of participants different from the first plurality of participants when the first participant from the subset of participants from the first plurality of participants does not accept the lead, the reassigning performed based on a second criteria list different from the first criteria list.

8. The method of claim 7, wherein the second plurality of participants is mutually exclusive from the first plurality of participants.
